(19) United States
(12) Patent Application Publication
(10) Pub. No.: US 2019/0119606 A1
(43) Pub. Date: Apr. 25, 2019

(54) METHOD FOR CLEANING HARD SURFACES, AND FORMULATIONS USEFUL FOR SAID METHOD

(71) Applicant: BASF SE, Ludwigshafen am Rhein (DE)

(72) Inventors: Frederic BAUER, Ludwigshafen (DE); Juergen TROPSCH, Ludwigshafen (DE); Juergen FRANKE, Ludwigshafen (DE); Nikolai DENKOV, Sofia (BG); Krastanka G. MARINOVA, Sofia (BG); Kristina T. NAYDENOVA, Sofia (BG)

(73) Assignee: BASF SE, Ludwigshafen am Rhein (DE)

(21) Appl. No.: 16/091,353

(22) PCT Filed: Apr. 10, 2017
(86) PCT No.: PCT/EP2017/058497

§ 371 Date: Oct. 4, 2018

(30) Foreign Application Priority Data
Apr. 18, 2016 (EP) 16165715.0

(51) Int. Cl. C11D 1/94; C11D 11/00; C11D 17/00; C11D 3/33; C11D 3/37; C11D 3/20; B08B 3/00; B08B 3/08

(52) U.S. Cl. CPC C11D 1/94; C11D 11/0023; C11D 17/0043; C11D 3/33; C11D 1/72; C11D 3/2031; B08B 3/003; B08B 3/08; C11D 3/3788

(57) ABSTRACT

Process for cleaning hard surfaces, characterized in that said process is carried out using a foam based on a formulation comprising: (A) at least one complexing agent selected from the alkali metal salts of aminocarboxylic acids and from alkali metal salts of citric acid, gluconic acid, tartaric acid and lactic acid, (B) at least one non-ionic surfactant of general formula (I): (G)x-OR¹, (C) at least one anionic surfactant, (D) at least one zwitterionic surfactant, wherein: R¹ is selected from C₈-C₁₈-alkyl, straight chain or branched, x is in the range of from 1.1 to 4, G selected from monosaccharides with 4 to 6 carbon atoms.

The present invention is directed towards a process for cleaning hard surfaces, characterized in that said process is carried out using a foam based on a formulation comprising
(A) at least one complexing agent selected from the alkali metal salts of aminocarboxylic acids and from alkali metal salts of citric acid, gluconic acid, tartaric acid and lactic acid,
(B) at least one non-ionic surfactant of general formula (I)

(G)ₓ-OR¹ (I)
(C) at least one anionic surfactant,
(D) at least one zwitterionic surfactant,
   wherein:
   R¹ is selected from C₈-C₁₈-alkyl, straight chain or branched,
   x is in the range of from 1.1 to 4,
   G selected from monosaccharides with 4 to 6 carbon atoms.

In addition, the present invention refers to formulations useful for the above process.

Hard surface cleaning is a field of ide economic interest. All sorts of hard surfaces that are exposed to soiling, to pollution or the like need to be cleaned. Especially large amount of pieces or large areas of hard surfaces call for processes that are easy in application and efficient in soil removal, including environmentally friendly in by-products.

Automatic dishwashing is a special aspect of hard surface cleaning. While automatic dishwashing usually makes use of detergents that cause little to no foam in other embodiments, for example so-called open plant cleaning—in brief OPC—open, freely accessible surfaces a cleaned in a multi-step cleaning process. Foam cleaning is considered advantageous in cases where complex structures need to be cleaned, with parts that are hard to reach, morphologically complex, or manually arduous. Particularly significant are applications in food and beverage industry. After one or more optional pre-cleaning steps that may be performed depending on the type and degree of soiling, for example manual cleaning steps with a tool, e.g., with a brush or a scrubber or a mop, and a high-pressure jet cleaning—high pressure amounting to 20 to 40 bar, key step is a foam cleaning step.

The foam applied in a foam cleaning step usually has to meet a lot of requirements. It has to be stable in a wide pH value range, for example from 2 to 14.5. It has to be stable for some time, for example 10 to 20 minutes, achieve good soil penetration and to support the detachment of soil. Foam should be tolerant to active chlorine and to active oxygen, and it has to adhere to vertical surfaces as walls, and even to the ceiling. However, after application it should be easy to break and decompose after use.

Accordingly, the process defined at the outset has been found, hereinafter also being referred to as inventive process or process according to the present invention.

The inventive process is a process for cleaning hard surfaces. Hard surfaces as used in the context with the present invention are defined as surfaces of water-insoluble and—preferably—non-swellable materials. In addition, hard surfaces as used in the context of the present invention are insoluble in acetone, white spirit (mineral turpentine), and ethyl alcohol. In addition, hard surfaces as used in the context of the present invention exhibit resistance against bending and manual destruction such as scratching with fingernails. Preferably, they have a Mohs hardness of 3 or more. Examples of hard surfaces are glassware, tiles, stone, china, enamel, concrete, leather, steel, other metals such as iron or aluminum, furthermore wood, plastic, in particular melamine resins, polyethylene, polypropylene, PMMA, polycarbonates, polyesters such as PET, furthermore polystyrene and PVC, and furthermore, silicon (wafers) surfaces. Particularly advantageous are formulations according to the invention when used for cleaning hard surfaces that are at least part of structured objects. In the context, such structured objects refer to objects having, e. g. convex or concave elements, notches, furrows, corners, or elevations like bumps.

Hard surfaces in the context of the present invention may be parts of buildings, automotive including cars and trucks, trains, and in particular plants and parts of plants, especially storage vessels, containers, conveyor belts, hooks, cutting tools including saws, means for heaving and rooms such as storage rooms, manufacturing rooms, slaughterhouses, stables, tanks such as silos, filling stations, and conveyors in the food and beverage industry. Further examples are swimming pools, tubs including but not limited to bath tubs, reels, piles, and—in general—tiles and stainless steel surfaces.

Before applying the inventive process such hard surfaces are soiled, for example with fatty or non-fatty residues, pigments, blood, urine, and the like. By application of the inventive process a major share of said soiling is being removed, for example of from 60 to 100% by weight, preferably 85 to 99.9% by weight and even more preferably 95 to 99.5% by weight.

The inventive process may comprise several steps, for example one or more pre-cleaning steps as outlined above, or a polishing step.

In one step of the inventive process, a foam is used. Foams contemplated in the present invention usually comprise gas bubbles, especially air bubbles, surrounded by a spheroidal membrane of cleaning formulation that includes at least complexing agent (A), surfactant (B), surfactant (C), surfactant (D), and at least one solvent, for example water or an organic solvent or a combination therefrom.

The inventive process is characterized in that said process is carried out using a foam based on at least one formulation comprising complexing agent (A), surfactant (B), surfactant (C), and surfactant (D). Complexing agent (A), surfactant (B), surfactant (C), and surfactant (D) shall be described in more detail below.

Complexing agent (A) is selected from the alkali metal salts of aminocarboxylic acids and from alkali metal salts of citric acid, tartaric acid and lactic acid. Alkali metal salt are selected from lithium salts, rubidium salts, cesium salts, potassium salts and sodium salts, and combinations of at least two of the foregoing. Potassium salts and combinations from potassium and sodium salts are preferred and sodium salts are even more preferred.

Specific examples of complexing agents are potassium and sodium salts of citric acid, gluconic acid, tartaric acid and lactic acid. Preferred specific examples are the trisodium salt of citric acid, the disodium monopotassium salt of citric acid and the tripotassium salt of citric acid.

Examples of aminocarboxylic acids are imino disuccinic acid (IDS), ethylene diamine tetraacetic acid (EDTA), nitrilotriacetic acid (NTA), methylglycine diacetic acid (MGDA) and glutamic acid diacetic acid (GLDA).

Preferred examples of alkali metal salts of aminocarboxylic acids are compounds according to general formula (II)

[R²—CH(COO)—N(CH₂—COO)₂]M_{3-y}H_{y} (IY)

wherein

M is selected from alkali metal cations, same or different, for example cations of lithium, sodium, potassium, rubidium, cesium, and combinations of at least two of the foregoing. Preferred examples of alkali metal cations are sodium and potassium and combinations of sodium and potassium.

y is in the range of from zero to 1.0, preferred are zero to 0.5. In a particularly preferred embodiment, y is zero.

R² is selected from hydrogen and C₁-C₄-alkyl, for example methyl, ethyl, iso-propyl, sec.-butyl and iso-butyl, preferably methyl.

In one embodiment of the present invention, aminocarboxylic acid is selected from compounds according to general formula (III)

[OOC—CH₂CH₂C—CH(COO)—N(CH₂—COO)₂]M_{4-y}H_{y} (III)

wherein
M is selected from alkali metal cations, same or different, as defined above, preferred are sodium and potassium and combinations of sodium and potassium, and even more preferred is sodium,
y is in the range of from zero to 2.0, preferred are zero to 0.5. In a particularly preferred embodiment, y is zero.

The trialkali metal salts of methylglycine diacetic acid (MGDA) and glutamic acid diacetic acid (GLDA) and combinations thereof, for example 1:2 to 2:1 by weight mixtures, are a preferred embodiment.

MGDA and its respective alkali metal salts may be selected from the racemic mixtures, the Disomers and the L-isomers, and from mixtures of the D- and L-isomers other than the racemic mixtures. Preferably, MGDA and its respective alkali metal salts are selected from the racemic mixture and from mixtures containing in the range of from 55 to 95 mole-% of the L-isomer, the balance being D-isomer. Particularly preferred are mixtures containing in the range of from 60 to 80 mole-% of the L-isomer, the balance being D-isomer.

Surfactant (B) is selected from non-ionic surfactants of general formula (I)

(G)ₓ—OR¹ (I)

wherein

R¹ is selected from C₈-C₁₈-alkyl, straight chain or branched, for example n-octyl, isooctyl, 2-hexylethyl, n-nonyl, isononyl, n-decyl, iso-decyl, 2-n-propylheptyl, 2-isopropyl-5-methylhexyl, n-undecyl, iso-undecyl, n-dodecyl, iso-dodecyl, 2-n-butyloctyl, n-tetradecyl, n-hexadecyl, and noctadecyl. Branched moieties R¹ are preferred, for example 2-hexylethyl, isononyl, iso-decyl, 2-n-propylheptyl, 2-isopropyl-5-methylhexyl, 2-n-butyloctyl and in particular 2-hexylethyl and 2-n-propylheptyl.

x is in the range of from 1.1 to 4, preferred are 1.1 to 2 and in particularly preferred are 1.2 to 1.8. In the context of the present invention, x refers to average values, and x is not necessarily a whole number. In a specific molecule only whole groups of G can occur. It is preferred to determine x by High Temperature Gas Chromatography (HTLC). In single molecules, there may be, for example, only one G moiety or up to 15 G moieties per molecule.

G is selected from monosaccharides with 4 to 6 carbon atoms, for example tetroses, pentoses, and hexoses. Examples of tetroses are erythrose, threose, and erythulose. Examples of pentoses are ribulose, xylulose, ribose, arabinose, xylose and lyxose. Examples of hexoses are galactose, mannose and glucose. Monosaccharides may be synthetic or derived or isolated from natural products, hereinafter in brief referred to as natural saccharides or natural polysaccharides, and natural saccharides natural polysaccharides being preferred. More preferred are the following natural monosaccharides: galactose, arabinose, xylose, and mixtures of the foregoing, even more preferred are glucose, arabinose and xylose, and in particular glucose. Monosaccharides can be selected from any of their enantiomers, naturally occurring enantiomers and naturally occurring mixtures of enantiomers being preferred.

In one embodiment of the present invention, G is selected from monosaccharides, preferably from glucose.

In single molecules of formula (I) with 2 or more monosaccharide groups, the glycosidic bonds between the monosaccharide units may differ in the anomeric configuration (α-; β-) and/or in the position of the linkage, for example in 1,2-position or in 1,3-position and preferably in 1,6-position or 1,4-position.

Surfactants (B) are usually mixtures of various compounds that have a different degree of polymerization of the respective saccharide. It is to be understood that in formula (I), x is a number average value, preferably calculated based on the saccharide distribution determined by high temperature gas chromatography (HTGC), e.g. 400° C., in accordance with K. Hill et al., Alkyl Polyglycosides, VCH Weinheim, N.Y., Basel, Cambridge, Tokyo, 1997, in particular pages 28 ff., or by HPLC. If the values obtained by HPLC and HTGC are different, preference is given to the values based on HTGC.

In a preferred embodiment, surfactant (B) is selected from those compounds according to formula (I) in which G is glucose, R¹ is n-C₈- or C₁₀-alkyl or mixtures thereof, and x is a number from 1.2 to 1.8.

Examples of surfactants (C) are linear C₆-C₂₀-alkylbenzenesulfonate, paraffin sulfonates, fatty alcohol sulphates, n-C₆-C₂₀-alkylethersulfonates, n-C₆-C₂₀-alkylethercarboxylates and fatty alcohol ether sulphates. Surfactants (C) are anionic surfactants. In the inventive process they are usually used in form of their respective alkali metal salts, preferably in form of their respective potassium salts and even more preferably in form of their sodium salts. Particularly preferred examples of surfactants (C) are compounds according to general formula (IV)

R³—(O—CH₂CH₂)ₐ—OSO₃M¹ (IV)

wherein
R³ is selected from C₆-C₂₀-alkyl, branched or preferably straight chain, for example n-hexyl, n-octyl, n-decyl, iso-decyl, n-undecyl, n-dodecyl, iso-dodecyl, n-tetradecyl, n-hexadecyl, noctadecyl, preferred are n-dodecyl, n-tetradecyl, n-hexadecyl and combinations of at least two of the foregoing.
a is a number in the range of from 1 to 10, preferably 1 to 4, even more preferably 1 to 3,
M¹ is selected from ammonium and alkali metal cations, same or different, for example cations of lithium, sodium, potassium, rubidium, cesium, and combinations of at least two of the foregoing. Preferred examples of alkali metal cations are sodium and potassium and combinations of sodium and potassium, preferred are sodium and potassium and combinations of sodium and potassium, and even more preferred is sodium. Examples of ammonium cations are NH₄⁺ and alkylated ammonium, for example with C₁-C₄-alkyl alkylated ammonium, especially N(CH₃)₄⁺, N(C₂H₅)₄⁺, HN(CH₃)₃⁺, HN(C₂H₅)₃⁺, and ethanolammonium salts, for example triethanolammonium cations, N-methyl diethanolammonium cations, and N,N-dimethyl ethanolammonium.

Further examples of anionic surfactants (C) are carboxylates, for example sodium cocoyl sarcosinate.

In the context of the present invention, surfactants (D) may also be referred to as zwitterionic surfactants (D) or amphoteric surfactants (D). Under the conditions of the inventive process amphoteric surfactants (D) are those that bear a positive and a negative charge in the same molecule. Preferred examples of amphoteric surfactants (D) are so-called betaine surfactants.

Many examples of betaine-surfactants bear one quaternized nitrogen atom and one carboxylic acid group per molecule. A particularly preferred example of amphoteric surfactants is cocoamidopropyl betaine (lauramidopropyl betaine).

Further examples of amphoteric surfactants (D) are amine oxide surfactants, especially compounds of the general formula (V)

R⁴R⁵R⁶N→O (V)

wherein R⁴ and R⁵ and R⁶ are selected independently from each other of aliphatic, cycloaliphatic or C₂-C₄-alkylene C₁₀-C₂₀-alkylamido moieties. Preferably, R⁴ is selected from C₈-C₂₀-alkyl or C₂-C₄-alkylene C₁₀-C₂₀-alkylamido and R⁵ and R⁶ are both methyl.

A particularly preferred example is lauryl dimethyl aminoxide, sometimes also called lauramine oxide. A further particularly preferred example is cocoamidylpropyl dimethylaminoxide, sometimes also called cocoamidopropylamine oxide.

Another group of preferred examples of amphoteric surfactants (D) are alkali metal salts of Nalkyliminodipropionates, for example the mono- and disodium salts of compounds of formula (VI)

R⁷—N(CH₂CH₂COOH)₂ (VI)

with R⁷ being selected from n-C₈-C₂₀-alkyl, especially n-C₁₂H₂₅.

In a preferred embodiment, the inventive process is carried out using a foam based upon a formulation comprising
(A) at least one complexing agent selected from MGDA-Na₃, GLDA-Na₄, and IDS-Na₄, in each of which up to 10 mol-% of the sodium may be replaced by potassium,
(B) at least one compound according to formula (I) in which G is glucose, R¹ is n-C₈- or C₁₀-alkyl or mixtures thereof, and x is a number from 1.2 to 1.8
(C) at least one anionic surfactant selected from compounds according to general formula (IV*)

R³—(O—CH₂CH₂)ₐ—OSO₃M (IV*)
Wherein M is sodium, R³ is n-dodecyl, n-tetradecyl, n-hexadecyl or a combination of at least two of the foregoing, and variable a is a number in the range of from 2 to 5, preferably 3 or 4,
(D) cocoamidopropyl betaine.

The inventive process is carried out by using a foam based on a formulation comprising the above described complexing agents and surfactants. Said formulation is preferably an aqueous formulation. Formulations according to the invention may contain at least one non-aqueous solvent such as, but not limited to ethanol, isopropanol, ethylene glycol, diethylene glycol, triethylene glycol, mono-C₁-C₄-alkyl ethylene glycol, mono-C₁-C₄-alkyl diethylene glycol, or 1,2-propylene glycol. It is preferred, however, that the water content of formulations according to the invention outweighs the sum of the non-aqueous solvent(s), for example in a weight ratio of 100:1 to 5:1. In other embodiments, formulations according to the invention do not contain any non-aqueous solvent.

Examples of mono-C₁-C₄-alkyl ethylene glycols and of mono-C₁-C₄-alkyl diethylene glycols are ethylene glycol monomethyl ether, ethylene glycol monoethyl ether, ethylene glycol monoisopropyl ether, ethylene glycol mono-n-butyl ether, diethylene glycol monomethyl ether, diethylene glycol monoethyl ether, diethylene glycol mono-isopropyl ether, and diethylene glycol mono-n-butyl ether, the latter also being referred to as “butyldiglycol”.

Formulations used in the inventive process are preferably alkaline. In one embodiment of the present invention formulations used in the inventive process have a pH value in the range of from 8 to 14.5, preferably 10 to 14 and even more preferred from 12 to 14. The pH value may be adjusted by addition of an inorganic base, for example potassium hydroxide or preferably sodium hydroxide.

In one embodiment of the present invention, the inventive process is carried out by making a foam from a formulation comprising the above described surfactants and at least one of the above described complexing agents (A) and contacting said foam with the soiled hard surface to be cleaned. The foam is allowed to be in contact with the soiled hard surface to be cleaned, for example over a period of time in the range of from 1 minute to 30 minutes, and it is then removed, for example by rinsing with water, with or without applying pressure.

In order to make a foam all common ways are feasible. It is preferred, though, to dilute an aqueous formulation—hereinafter, also referred to as concentrate—comprising surfactants (B) to (D) and complexing agent (A) and, optionally, one or more further ingredients with water, for example in a ratio of 1:5 to 1:100, and then mix it with pressurized air, for example 15 to 30 bar, preferably 20 to 30 bar, and to release through a nozzle. Foam lances are useful appliances to perform the inventive process.

A foam made as indicated above is then applied to the hard surface to be cleaned. The amount of foam may be selected within wide ranges. For example, a layer with an average thickness of from 1 mm to 20 cm, preferably up to 10 cm may be applied.

In one embodiment of the present invention, the foam density, determined at 20° C., is in the range of from 25 to 500 g/liter (“g/l”), preferred are 50 to 250 g/l, and even more preferred are 75 to 200 g/l.

In one embodiment of the present invention, the inventive process is carried out at a temperature in the range of from 5 to 80° C., preferably 10 to 60° C. and even more preferably 10 to 40° C. Preferred temperature is ambient temperature.

In one embodiment of the present invention, the foam formed in the context of the inventive process has an average bubble diameter in the range of from 0.1 to 10 mm, preferably 0.15 to 5 mm and even more preferably 0.2 to 1 mm.

Formulations used for the inventive process may contain one or more further ingredients, for example one or more graft copolymers (E). Graft copolymers (E) are composed of
(a) at least one graft base, for short called graft base (a), selected from monosaccharides, disaccharides, oligosaccharides and polysaccharides,

and side chains obtainable by grafting on of
(b) at least one ethylenically unsaturated mono- or dicarboxylic acid, for short called monocarboxylic acid (b) or dicarboxylic acid (b),
(c) at least one ethylenically unsaturated N-containing monomer with a permanent cationic charge, for short called monomer (c), and, optionally, monomer (d)
(d) at least one C₁-C₄-alkyl ester of (meth)acrylic acid or at least one comonomer with a sulfonate group, for example 2-acrylamido-2-methylpropane sulfonic acid (“AMPS”), altogether also referred to as monomer (d).

Graft copolymer (E) shall be described in more detail below. Graft copolymer (E) may be used as free acid or as its alkali metal salts. In this context, alkali metal salts of graft copolymer (E) encompass partially and fully neutralized copolymer (E) wherein such neutralization is with alkali, especially with sodium.

Monosaccharides suitable as graft base (a) selected may be for example aldopentoses, pentuloses (ketopentoses), aldohexoses and hexuloses (ketohexoses). Suitable aldopentoses are e.g. D-ribose, D-xylose and L-arabinose. Aldohexoses that may be mentioned are D-glucose, D-mannose and D-galactose; examples of hexuloses (ketohexoses) to be mentioned are in particular D-fructose and D-sorbose.

In the context of the present invention, deoxy sugars such as, for example, L-fucose and L-rhamnose, should also be included among monosaccharides.

Examples of disaccharides which may be mentioned are, for example, cellobiose, lactose, maltose and sucrose.

In the context of the present invention, oligosaccharides that may be mentioned are carbohydrates with three to ten monosaccharide units per molecule, for example glycans. In the context of the present invention, polysaccharides is the term used to refer to carbohydrates with more than ten monosaccharide units per molecule. Oligo- and polysaccharides may be for example linear, cyclic or branched.

Polysaccharides to be mentioned by way of example are biopolymers such as starch and glycogen, and cellulose, dextran and tunicin. Furthermore, mention is to be made of inulin as polycondensate of D-fructose (fructans), chitin and alginic acid. Further examples of polysaccharides are starch degradation products, for example products which can be obtained by enzymatic or so-called chemical degradation of starch. Examples of the so-called chemical degradation of starch are oxidative degradation and acid-catalyzed hydrolysis.

Preferred examples of starch degradation products are maltodextrins and glucose syrup. In the context of the present invention, maltodextrin is the term used to refer to mixtures of monomers, dimers, oligomers and polymers of glucose. The percentage composition differs depending on the degree of hydrolysis. This is described by the dextrose equivalent, which in the case of maltodextrin is between 3 and 40.

Preferably, graft base (a) is selected from polysaccharides, in particular from starch, which is preferably not chemically modified. In one embodiment of the present invention, starch is selected from those polysaccharides which have in the range from 20 to 30% by weight amylose and in the range from 70 to 80% amylopectin. Examples are corn starch, rice starch, potato starch and wheat starch.

Side chains are grafted on to the graft base (a). Per molecule of graft copolymer (E), preferably on average one to ten side chains can be grafted on. Preferably, in this connection, a side chain is linked with the anomeric carbon atom of a monosaccharide or with an anomeric carbon atom of the chain end of an oligo- or polysaccharide. The number of side chains is limited upwards by the number of carbon atoms with hydroxyl groups of the graft base (a) in question.

Examples of monocarboxylic acids (b) are ethylenically unsaturated C₃-C₁₀-monocarboxylic acids and the alkali metal or ammonium salts thereof, in particular the potassium and the sodium salts. Preferred monocarboxylic acids (b) are acrylic acid and methacrylic acid, and also sodium (meth)acrylate. Mixtures of ethylenically unsaturated C₃-C₁₀ monocarboxylic acids and in particular mixtures of acrylic acid and methacrylic acid are also preferred components (b).

Examples of dicarboxylic acids (b) are ethylenically unsaturated C₄-C₁₀-dicarboxylic acids and their mono- and in particular dialkali metal or diammonium salts, in particular the dipotassium and the disodium salts, and anhydrides of ethylenically unsaturated C₄-C₁₀-dicarboxylic acids as well. Preferred dicarboxylic acids (b) are maleic acid, fumaric acid, itaconic acid, and also maleic anhydride and itaconic anhydride.

In one embodiment, graft copolymer (E) comprises in at least one side chain, besides monomer (c) at least one monocarboxylic acid (b) and at least one dicarboxylic acid (b). In a preferred embodiment of the present invention, graft copolymer (E) comprises in polymerized-in form in the side chains, besides monomer (c), exclusively monocarboxylic acid (b), but no dicarboxylic acid (b).

Examples of monomers (c) are ethylenically unsaturated N-containing compounds with a permanent cationic charge, i.e. those ethylenically unsaturated N-containing compounds that form ammonium salts with anions such as sulfate, C₁-C₄-alkyl sulfates and halides, in particular with chloride, and independently of the pH value. Any desired mixtures of two or more monomers (c) are also suitable.

Examples of suitable monomers (c) are the correspondingly quaternized derivatives of vinyland allyl-substituted nitrogen heterocycles such as 2-vinylpyridine and 4-vinylpyridine, 2-allylpyridine and 4-allylpyridine, and also N-vinylimidazole, e.g. 1-vinyl-3-methylimidazolium chloride. Also of suitability are the correspondingly quaternized derivatives of N,N-diallylamines and N,N-diallyl-N-alkylamines, such as e.g. N,N-diallyl-N,N-dimethylammonium chloride (DADMAC).

In one embodiment of the present invention, monomer (c) is selected from correspondingly quaternized, ethylenically unsaturated amides of mono- and dicarboxylic acids with diamines that have at least one primary or secondary amino group. Preference is given here to those diamines that have one tertiary and one primary or secondary amino group.

In another embodiment of the present invention, monomer (c) is selected from correspondingly quaternized, ethylenically unsaturated esters of mono- and dicarboxylic acids with C₂-C₁₂-amino alcohols which are mono- or dialkylated on the amine nitrogen.

Suitable acid components of the aforementioned esters and amides are e.g. acrylic acid, methacrylic acid, fumaric acid, maleic acid, itaconic acid, crotonic acid, maleic anhydride, monobutyl maleate and mixtures thereof. As acid component, preference is given to using acrylic acid, methacrylic acid and mixtures thereof.

Preferred monomers (c) are trialkylaminoethyl (meth)acrylatochloride or alkyl sulfate and trialkylaminopropyl (meth)acrylatochloride or alkyl sulfate, and also (meth)acrylamidoethyltrialkylammonium chloride or alkyl sulfate and (meth)acrylamidopropyltrialkylammonium chloride or alkyl sulfate, where the respective alkyl radical is preferably methyl or ethyl or mixtures thereof.

Very particular preference is given to (meth)acrylamidopropyltrimethylammonium halide, in particular acrylamidopropyltrimethylammonium chloride (“APTAC”) or methacrylamidopropyltrimethylammonium chloride (“MAPTAC”).

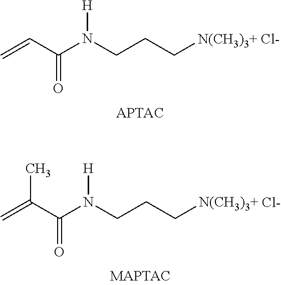

In another preferred embodiment of the present invention, monomer (c) is selected from trimethylammonium C₂-C₃-alkyl(meth)acrylatohalide, in particular 2-(trimethylamino)ethyl(meth)acrylatochloride and 3-(trimethylamino)propyl(meth)acrylatochloride.

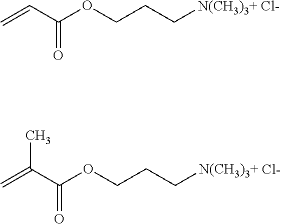

Graft copolymer (E) can comprise, in polymerized-in form, in one or more side chains at least one further monomer (d), for example hydroxyalkyl esters such as 2-hydroxyethyl (meth)acrylate or 3-hydroxypropyl (meth)acrylate or C₁-C₁₀-alkyl (meth)acrylates or esters of alkoxylated fatty alcohols, or comonomers containing sulfonic acid groups, for example 2-acrylamido-2-methylpropanesulfonic acid (AMPS) and its alkali metal salts.

Preferably, graft copolymer (E) comprises no further comonomers (d) in one or more side chains apart from monomer (c) and monocarboxylic acid (b) or dicarboxylic acid (b).

In one embodiment of the present invention, the fraction of graft base (a) in graft copolymer (E) is in the range from 40 to 95% by weight, preferably from 50 to 90% by weight, in each case based on total graft copolymer (E).

In one embodiment of the present invention, the fraction of monocarboxylic acid (b) or dicarboxylic acid (b) is in the range from 2 to 40% by weight, preferably from 5 to 30% by weight and in particular from 5 to 25% by weight, in each case based on total graft copolymer (E).

The monomers of type (c) are polymerized in in amounts of from 5 to 50% by weight, preferably from 5 to 40% by weight and particularly preferably from 5 to 30% by weight, in each case based on total graft copolymer (E).

It is preferred if graft copolymer (E) comprises, in polymerized-in form, more monocarboxylic acid (b) than compound (c), and specifically based on the molar fractions, for example in the range from 1.1:1 to 5:1, preferably 2:1 to 4:1.

In other embodiments, graft copolymers (E) are selected from guar (hydroxypropyl) trimonium chlorides.

In one embodiment of the present invention, the average molecular weight (M_{w}) of graft copolymer (E) is in the range from 2,000 to 2,000,000 g/mol, preferably from 5,000 to 150,000 and in particular in the range from 8,000 to 100,000 g/mol. The average molecular weight M_{w} is measured preferably by gel permeation chromatography in aqueous KCl/formic acid solution.

Graft copolymer (E) can preferably be obtained as aqueous solution from which it can be isolated, e.g. by spray drying, spray granulation or freeze drying.

If desired, solution of graft copolymer (E) or dried graft copolymer (E) can be used for producing the formulations according to the invention.

Monomer (c) per se can be polymerized in graft copolymer (E) or a non-quaternized equivalent, in the case of APTAC for example

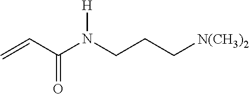

and in the case of MAPTAC with

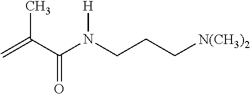

and the copolymerization can be followed by alkylation, for example with C₁-C₈-alkyl halide or di-C₁-C₄-alkyl sulfate, for example with ethyl chloride, ethyl bromide, methyl chloride, methyl bromide, dimethyl sulfate or diethyl sulfate.

It is preferred to stabilize graft copolymer (E) by at least one biocide. Examples of suitable biocides are isothiazolinones, for example 1,2-benzisothiazolin-3-one (“BIT”), octylisothiazolinone (“OIT”), dichlorooctylisothiazolinone (“DCOIT”), 2-methyl-2H-isothiazolin-3-one (“MIT”) and 5-chloro-2-methyl-2H-isothiazolin-3-ones (“CIT”), phenoxyethanol, alkylparabens such as methylparaben, ethylparaben, propylparaben, benzoic acid and its salts such as sodium benzoate, benzyl alcohol, alkali metal sorbates such as e.g. sodium sorbate, and (substituted) hydantoins such as e.g. 1,3-bis(hydroxymethyl)-5,5-dimethylhydantoin (DMDM hydantoin). Further examples are 1,2-dibromo-2,4-dicyanobutane, iodo-2-propynyl butylcarbamate, iodine and iodophores.

In one embodiment of the present invention, formulations used in the inventive process additionally contain

(F) at least one n-C₈-C₂₀-alkyl alcohol or at least one n-C₈-C₂₀-alkenyl alcohol, hereinafter each referred to fatty alcohol (F). Preferred fatty alcohols (F) have an even number of carbon atoms.

Examples of fatty alcohols (F) are n-octanol, n-nonanol, n-decanol, n-dodecanol, ntetradecanol, n-hexadecanol, and n-octadecanol. Further examples of fatty alcohols (F) are linear (Z)-alkenols, for examples linear (Z)-hexadecenol and linear (Z)-octadecenol. Mixtures of at least two fatty alcohols (F) are preferred. The presence of fatty alcohol (F) improves the rinse behaviour during and after removal of the foam.

In one embodiment of the present invention, formulations used in the inventive process additionally contain at least one further ingredient (G) that is neither a complexing agent (A) nor any of surfactants (B) to (D) nor a graft copolymer (E) nor an alcohol (F). Examples of such further ingredients (G) are polymers that are not graft copolymers, hererinafter also referred to as polymers (G), and bleaching agents. Examples of bleaching agents are alkali metal hyopchlorites such as sodium hypochlorite NaOCl, potassium hypochlorite KOCl, and the like, hydrogen peroxide, and sodium persulphate. Examples of polymers (G) are polyacrylates such as polyacrylic acid, partially or preferrably fully neutralized with alkali metal, especially with sodium.

In one embodiment of the present invention, formulations used in the inventive process comprise
(A) in total in the range of from 0.5 to 10% by weight of complexing agent (A), preferably 1 to 10% by weight,
(B) in total in the range of from 0.1 to 5% by weight of surfactant (B),
(C) in total in the range of from 0.1 to 10% by weight of anionic surfactant (C),
(D) in total in the range of from 0.1 to 5% by weight of zwitterionic surfactant, and, optionally,
(E) in the range of from 0.02 to 5% by weight of graft copolymer (E), preferably 0.05 to 3% by weight,
   and, optionally,
(F) in total in the range of from 0.05 to 5% by weight of one n-C₈-C₂₀-alkyl alcohol or at least one n-C₈-C₂₀-alkenyl alcohol, preferably 0.1 to 5% by weight,
   percentages being based on the total respective formulation.

By the inventive process hard surfaces may be cleaned very efficiently, especially from fatty soiling. The foam exhibits sufficient stability, even when sticking to the ceiling of a container or vessel. Upon removal, the foam collapses quite quickly.

Another aspect of the present invention is directed towards formulations, preferably aqueous formulations. Said formulations are hereinafter also referred to as inventive formulations or as formulations according to the present invention. Inventive formulations comprise
(A) at least one complexing agent selected from the alkali metal salts of aminocarboxylic acids and from alkali metal salts of citric acid, gluconic acid, tartaric acid and lactic acid,
(B) at least one non-ionic surfactant of general formula (I)

(G)ₓ—OR¹ (I)
(C) at least one anionic surfactant,
(D) at least one zwitterionic surfactant,
wherein:
R¹ is selected from C₈-C₁₈-alkyl, straight chain or branched,
x is in the range of from 1.1 to 4,
G is selected from monosaccharides with 4 to 6 carbon atoms.

Complexing agent (A), surfactant (B), surfactant (C) and zwitterionic surfactant (D) have been defined above.

In one embodiment of the present invention, inventive formulations additionally contain
(E) at least one graft copolymer composed of
(a) at least one graft base selected from monosaccharides, disaccharides, oligosaccharides and polysaccharides,
   and side chains obtainable by grafting on of
(b) at least one ethylenically unsaturated mono- or dicarboxylic acid and
(c) at least one ethylenically unsaturated N-containing monomer with a permanent cationic charge, and, optionally,
(d) at least one C₁-C₄-alkyl ester of (meth)acrylic acid or at least one comonomer with a sulfonate group.

In a preferred embodiment of the present invention complexing agent (A) is selected from the alkali metal salts of methyl glycine diacetate (MGDA), imino disuccinic acid (IDS) and glutamic acid diacetate (GLDA).

In a preferred embodiment of the present invention graft copolymer (E) has an average molecular weight M_{w} in the range of from 2,000 to 200,000 g/mol, preferably from 5,000 to 150,000 and in particular in the range from 8,000 to 100,000 g/mol.

In a preferred embodiment of the present invention graft copolymer (E) is used as its alkali metal salt which includes partially and fully neutralized graft copolymer (E).

In a preferred embodiment of the present invention, inventive aqueous formulation has a pH value in the range of from 12 to 14 or even up to 14.5.

In a preferred embodiment of the present invention inventive formulations contain
(F) at least one n-C₈-C₂₀-alkyl alcohol or at least one n-C₈-C₂₀-alkenyl alcohol.

In one embodiment of the present invention, inventive formulations contain at least one further ingredient (G) that is neither a complexing agent (A) nor any of surfactants (B) to (D) nor a graft copolymer (E) nor an alcohol (F). Examples of such further ingredients (G) are polymers that are not graft copolymers, hererinafter also referred to as polymers (G), and bleaching agents. Examples of bleaching agents are alkali metal hyopchlorites such as sodium hypochlorite NaOCl, potassium hypochlorite KOCl, and the like, hydrogen peroxide, and sodium persulphate. Examples of polymers (G) are polyacrylates such as polyacrylic acid, partially or preferrably fully neutralized with alkali metal, especially with sodium.

Further examples of further ingredients (G) are dyestuffs, fragrances,

In one embodiment of the present invention inventive formulations contain
(A) in total in the range of from 0.1 to 25% by weight of complexing agent (A), preferably 0.25 to 20% by weight and more preferably 0.5 to 15% by weight,
(B) in total in the range of from 0.1 to 5% by weight of surfactant (B), preferably 0.25 to 7.5% by weight and more preferably 0.5 to 5% by weight,
(C) in total in the range of from 0.1 to 10% by weight of anionic surfactant (C), preferably 0.25 to 7.5% by weight and more preferably 0.5 to 7.5% by weight,
(D) in total in the range of from 0.1 to 10% by weight of zwitterionic surfactant (D), preferably 0.25 to 7.5% by weight and more preferably 0.5 to 5% by weight, and, optionally, (E) in the range of from 0.005 to 5% by weight of graft copolymer (E), preferably 0.01 to 2.5% by weight and more preferably 0.01 to 2% by weight, and, optionally,
(F) in total in the range of from 0.1 to 5% by weight of one n-C₈-C₂₀-alkyl alcohol or at least one n-C₈-C₂₀-alkenyl alcohol, preferably 0.01 to 2.5% by weight and more preferably 0.01 to 2% by weight,
   percentages being based on the total respective formulation.

In a preferred embodiment, inventive formulations comprise
(A) at least one complexing agent selected from MGDA-Na₃, GLDA-Na₄, and IDS-Na₄, in each of which up to 10 mol-% of the sodium may be replaced by potassium,
(B) at least one compound according to formula (I) in which G is glucose, R¹ is n-C₈- or C₁₀-alkyl or mixtures thereof, and x is a number from 1.2 to 1.8,
(C) at least one anionic surfactant selected from compounds according to general formula (IV*)

R³—(O—CH₂CH₂)ₐ—OSO₃M (IV*)
Wherein M is sodium, R³ is n-dodecyl, n-tetradecyl, n-hexadecyl or a combination of at least two of the foregoing, and variable a is a number in the range of from 2 to 5, preferably 3 or 4,
(D) cocoamidopropyl betaine.

In one embodiment of the present invention, inventive formulations have a total active components content in the range of from 10 to 60% by weight, preferably 15 to 50% by weight and even more preferably 17.5 to 45% by weight. The total active components content may be determined by evaporation of all volatile components at 110° C. at normal pressure for 60 minutes. The total active components content according to the above definition includes base, if present.

Inventive formulations may be manufactured by mixing the components in the presence or preferably in the absence of water. In a preferred embodiment, a vessel is charged with water or aqueous sodium hydroxide solution or aqueous potassium hydroxide solution. Then, surfactant (B), surfactant (C) and surfactant (D) are added, followed by addition of complexing agent (A) as solid or preferably as aqueous solution. Then, water and, optionally, an organic solvent such as butyldiglycol may be added. In other embodiments, an aqueous solution of surfactant (B), surfactant (C) and surfactant (D) is provided, followed by addition of complexing agent (A) as solid or preferably as aqueous solution, and followed by subsequent adjustment of the pH value with aqueous KOH or NaOH solution

In another preferred embodiment, a vessel is charged with graft copolymer (E) and alcohol (F) followed by addition of by addition of complexing agent (A) as solid or preferably as aqueous solution. Then, water and, optionally, an organic solvent such as butyldiglycol are added, followed by adjustment of the pH value with aqueous KOH or NaOH solution.

Inventive formulations are excellently suitable for carrying out the inventive process.

The present invention is further illustrated by the following working examples.

The following ingredients were used:

(A.1): MGDA as trisodium salt, MGDA-Na₃, provided as 40% by weight aqueous solution
(B.1): a compound according to formula (I) wherein G is glucose, x is 1.7 and R¹ is n-C₆-C₁₀-alkyl with a maximum at and average of n-C₈H₁₇.
(B.2): a compound according to formula (I) wherein G is glucose, x is 1.7 and R¹ is n-C₈-C₁₄-alkyl with a maximum at and average of n-C₁₀H₂₁.
(C.1): n-C₁₂H₂₅—(O—CH₂CH₂)₃—OSO₃Na, provided as 70% by weight aqueous solution
(C.2): sodium cocoyl sarcosinate
(C.3): sodium salt of 2-ethylhexyl sulfate
(D.1): cocamidopropyl-betaine, provided as 30% by weight aqueous solution
(D.2): mono-sodium salt of n-C₁₂H₂₅—N(CH₂CH₂COOH)₂
(E.1): graft copolymer according to WO 2015/197378, example 2
(F.1): a mixture of n-C₁₂-C₁₈-alcanols, non-branched

Foaming—General Protocol:

A multi-dosing foam cleaning device of the model “BOBBY-BK-1200/20-VA”, hereinafter also referred to as “Bobby”, equipped with a mixing device of the type “0499-rr” and a foam injector lance of the type “95-F-3”, equipped with a nozzle of the type “S.S. CO 43/8 U SSVEE Jet-S-” was used for the foam tests. The Bobby was connected to a tap water supply with a water hardness of 11° dH, 20° C. and 3bar pressure. The Bobby is commercially available from Bobby Joseph Vilsmeier GmbH & Co. KG.

The suction hose connected on the mixing device of the type “0499-rr” was then dipped into the test formulation and the operation mode set on “Chemie” and a working pressure of 55bar. The mixing device “0499-rr” was adjusted to operate on a dilution of 5 g test formulation in 95 g tap water. Before the test as such started 1 liter of test solution was foamed with the Bobby to precondition all parts of the Bobby.

I. Manufacture of inventive aqueous formulations

The following general procedure was followed for IF.1 and IF.2:

A vessel was charged with water. Then, in accordance with Table 1 surfactant (B.1) and surfactant (B.2) were added under stirring until a clear solution was obtained. Then, surfactant (C.1) and surfactant (D.1) were added under stirring until a clear solution was obtained. Then, complexing agent (A.1) was added as 40% aqueous solution were added under stirring until a clear solution was obtained. Butyldiglykol and 5 g of 25% by weight aqueous NaOH solution were added at the end.

TABLE 1
composition of inventive formulations IF.1 and IF.2

| | | | | | | | | | oth- |
|---|---|---|---|---|---|---|---|---|---|
| | (A.1) | (B.1) | (B.2) | (C.1) | (D.1) | (D.2) | (F.1) | NaOH | ers |
| IF.1 | 5.0 | 0.65 | 0.7 | 3.0 | 0.65 | — | 0.5 | 5 | 1.5 |
| | | | | | | | | | BDG |
| IF.2 | 5.0 | 0.7 | 0.8 | 2.0 | 1.5 | — | 0.5 | 5 | 1.5 |
| | | | | | | | | | BDG |

BDG: diethylene glycol mono-n-butyl ether
Others: other than water

All amounts refer to active compound and are in g per 100 g of formulation.

Foams of IF.1 and IF.2 were formed by 10 vigorous shakings by hand of a closed cylinder, total volume: 130 ml, graduated to 100 ml with increments of 1 ml, containing 40 ml solution and 90 ml air. The upper and the lower boundaries of the foams in the cylinders were monitored during 10 minutes.

For IF.3 and further inventive formulations, the following general procedure was followed: A vessel was charged with water. Then, in accordance with Table 1 surfactant (B.1) and surfactant (B.2) were added under stirring until a clear solution was obtained. Then, surfactant (C.1) and surfactant (D.1) were added under stirring until a clear solution was obtained. Then, complexing agent (A.1) was added as 40% aqueous solution were added under stirring until a clear solution was obtained. Butyldiglykol and 5 g of 25% by weight aqueous NaOH solution were added at the end.

TABLE 2
composition of further inventive formulations

| | (A.1) | (B.1) | (B.2) | (C.1) | (D.1) | (D.2) | (F.1) | NaOH | KOH | others |
|---|---|---|---|---|---|---|---|---|---|---|
| IF.3 | 5.0 | 0.9 | 1.1 | 2.0 | 1.0 | — | 0.5 | 5.0 | — | 6.0 BDG |
| IF.4 | 5.0 | 0.9 | 1.1 | 2.0 | 1.0 | 0.3 | 0.5 | 7.5 | — | 6.0 BDG |
| IF.5 | 5.0 | 0.9 | 1.1 | 2.0 | 1.0 | 1.2 | 0.5 | 10.0 | — | 6.0 BDG |
| IF.6 | 5.0 | 0.9 | 1.1 | 2.0 | 1.0 | — | 0.5 | 20.0 | — | 6.0 BDG |
| IF.7 | 5.0 | 0.9 | 1.1 | 2.0 | 1.0 | — | 0.5 | 3.75 | 3.75 | 6.0 BDG |
| IF.8 | 5.0 | 0.9 | 1.1 | 2.0 | 1.0 | 0.8 | 0.5 | 5.0 | 5.0 | 6.0 BDG |
| IF.9 | 5.0 | 0.9 | 1.1 | 2.0 | 1.0 | 2.0 | 0.5 | 10.0 | 10.0 | 6.0 BDG |
| IF.10 | 5.0 | 0.9 | 1.1 | 2.0 | 1.0 | 2.2 | 0.5 | — | 15.0 | 6.0 BDG |
| IF.11 | 5.0 | 0.9 | 1.1 | 2.0 | 1.0 | 1.0 | 0.5 | 7.5 | — | 6.0 BDG |
| IF.12 | 5.0 | 0.9 | 1.1 | 2.0 | 1.0 | 2.4 | 0.5 | 10.0 | — | 6.0 BDG |

All amounts refer to active compound and are in g/100 g.

II. Manufacture of Foams from Inventive Formulations, and Cleaning Properties

Inventive formulations were diluted with water, 11° dH (German hardness)—permanent—in a ratio of about 1:25 at 22° C. The Bobby was then operated according to the foaming protocol and produced foam according to the invention.

The foam densities p were determined in a polymer beaker of 6.116 I volume at 20° C. The foam was made as follows: formulation was foamed with a Bobby, and the polymer beaker was filled with it. The outer surface of the beaker was dried with a piece of cloth, and the supernatant amount of foam removed with a blade. The weight difference empty polymer beaker/polymer beaker with foam was assigned to the foam.

The dynamic viscosities rl were determined at 23° C. according to Brookfield, spindle 18, 100 rounds per min. The pH value was determined after a dilution with water, ratio 1:24.

TABLE 3
properties of formulations and foams

| | pH | η | ρ | Appearance |
|---|---|---|---|---|
| | value | [mPa · s] | [g/100 ml] | after 5 days |
| IF.3 | 12.7 | 4.32 | 12.3 | clear solution |
| IF.4 | 12.8 | 6.51 | n.d. | clear solution |
| IF.5 | 13.0 | 10.60 | n.d. | clear solution |
| IF.6 | 13.2 | n.d. | n.d. | clear solution |
| IF.7 | 12.8 | 5.13 | | clear solution |
| IF.8 | 12.9 | 7.26 | | clear solution |
| IF.9 | 13.2 | n.d. | | clear solution |
| IF.10 | 13.1 | 10.2 | | clear solution |
| IF.11 | 12.8 | 6.48 | | clear solution |
| IF.12 | 12.9 | 10.50 | | clear solution |
| CF.13 | 13.0 | | 15.7 | clear solution |

n.d.: not determined

For comparative purposes, a commercially available formulation CF.13 was used. Formulation CF.13 was an aqueous formulation containing (all amounts refer to 100 g): 5 g NaOH, 5 g EDTA-Na₄, 3 g BDG, and 5 g (C.2).

Three types of cleaning experiments were performed:

II.1 Cleaning Experiment 1—Foam Breaking

In order to determine how fast the foams break—collapse—the following experiments were performed: A 30-I-plastic vessel was filled with about 700 g of foam from the Bobby. Then, the plastic vessel was placed upside down over a kitchen sink. The beaker was then rinsed with water so that the water and foam would run into the kitchen sink. The time t_{cold} was determined when no more foam could visually be seen in the kitchen sink.

In order to determine the collapse time at 55° C., the experiments were repeated but water of 55° C. was used for rinsing. The time determined is tₕₒₜ.

The results are summarized in Table 4. Since slightly different amounts of foam were produced, the figure to be compared was the foam removal velocity, FRV, expressed in g foam/s. Generally, a high FRV is desirable. Foam made from 2.5% aqueous NaOH shows good FRV but is not capable of removing any lard.

II.2 Cleaning Experiment 2—Stability of Foam

With the Bobby, foam was sprayed against a clean vertical steel sheet. The run-off performance was determined. It is summarized in Table 4.

II.3 Lard Removal

A stainless steel test panel coated with a 30 μm layer of lard was covered with foam from the Bobby, vide supra.

After 20 minutes the steel panel was rinsed with the Bobby. The operation mode of the mixing device “0499-rr” was set to “Reinigen” and the working pressure was set to 50b ar. The Bobby was supplied by tap water of a water hardness of 11° dH, 20° C. and 3 bar. The duration of the rinsing step was 60 s. The results are summarized in Table 4.

CF.13 did not exhibit acceptable lard removal properties.

TABLE 4
Cleaning performance of formulations and foams

| | | | | | run-off | lard |
|---|---|---|---|---|---|---|
| | t_{cold} | tₕₒₜ | FRV_{cold} | FRVₕₒₜ | performance, | removal, |
| | [s] | [s] | [g/s] | [g/s] | II.2 | II.3 |
| IF.3 | 105 | n.d. | 10.4 | 7.7 | Excellent | Excellent |
| IF.5 | 65 | 95 | 10.0 | 9.1 | Excellent | Excellent |
| IF.6 | 70 | 100 | 10.2 | 8.1 | Excellent | Excellent |
| IF.11 | 75 | 70 | 11.8 | 8.5 | Excellent | Excellent |
| IF.12 | 95 | 85 | 8.0 | 10.8 | Excellent | Excellent |
| 2.5% NaOH | 110 | 105 | 7.8 | 7.2 | Instable | No lard |
| | | | | | | removal |

1: A process for cleaning hard surfaces, comprising:
cleaning a hard surface with a foam comprising a formulation, comprising
(A) at least one complexing agent selected from alkali metal salts of aminocarboxylic acids and from alkali metal salts of citric acid, gluconic acid, tartaric acid and lactic acid,
(B) at least one non-ionic surfactant of formula (I)
(G)ₓ—OR¹ (I)
(C) at least one anionic surfactant, and
(D) at least one zwitterionic surfactant,
wherein:
R¹ is selected from C₈-C₁₈-alkyl, straight chain or branched,
x is in the range of from 1.1 to 4,
G selected from monosaccharides with 4 to 6 carbon atoms.

2: The process according to claim 1, wherein
said formulation additionally comprises:
(E) at least one graft copolymer comprising
(a) at least one graft base selected from monosaccharides, disaccharides, oligosaccharides and polysaccharides,
and side chains obtained by grafting on of
(b) at least one ethylenically unsaturated mono- or dicarboxylic acid and
(c) at least one ethylenically unsaturated N-containing monomer with a permanent cationic charge, and, optionally
(d) at least one C₁-C₄-alkyl ester of (meth)acrylic acid or at least one comonomer with a sulfonate group.

3: The process according to claim 1, wherein complexing agent (A) is selected from the alkali metal salts of methyl glycine diacetate (MGDA), imino disuccinic acid (IDS) and glutamic acid diacetate (GLDA).

4: The process according to claim 2, wherein graft copolymer (E) has an average molecular weight M_{w} in the range of from 2,000 to 200,000 g/mol.

5: The process according to claim 2, wherein graft copolymer (E) is used as its alkali metal salt.

6: The process according to claim 1, wherein said formulation has a pH value in the range of from 12 to 14.

7: The process according to claim 1, wherein said formulation further comprises:
(F) at least one n-C₈-C₂₀-alkyl alcohol or at least one n-C₈-C₂₀-alkenyl alcohol.

8: A formulation, comprising:
(A) at least one complexing agent selected from alkali metal salts of aminocarboxylic acids and from alkali metal salts of citric acid, gluconic acid, tartaric acid and lactic acid,
(B) at least one non-ionic surfactant of formula (I)
(G)ₓ—OR¹ (I)
(C) at least one anionic surfactant, and
(D) at least one zwitterionic surfactant,
wherein:
R¹ is selected from C₈-C₁₈-alkyl, straight chain or branched,
x is in the range of from 1.1 to 4,
G selected from monosaccharides with 4 to 6 carbon atoms.

9: The formulation according to claim 8,
wherein said formulation additionally comprises:
(E) at least one graft copolymer comprising
(a) at least one graft base selected from monosaccharides, disaccharides, oligosaccharides and polysaccharides,
and side chains obtained by grafting on of
(b) at least one ethylenically unsaturated mono- or dicarboxylic acid and
(c) at least one ethylenically unsaturated N-containing monomer with a permanent cationic charge, and, optionally,
(d) at least one C₁-C₄-alkyl ester of (meth)acrylic acid or at least one comonomer with a sulfonate group.

10: The formulation according to claim 8, wherein complexing agent (A) is selected from the alkali metal salts of methyl glycine diacetate (MGDA), imino disuccinic acid (IDS) and glutamic acid diacetate (GLDA).

11: The formulation according to claim 9, wherein graft copolymer (E) has an average molecular weight M_{w} in the range of from 2,000 to 2,000,000 g/mol.

12: The formulation according to claim 9, wherein graft copolymer (E) is used as its alkali metal salt.

13: The formulation according to claim 8, wherein said formulation has a pH value in the range of from 12 to 14.

14: The formulation according to claim 8, wherein said formulation further comprises:
(F) at least one n-C₈-C₂₀-alkyl alcohol or at least one n-C₈-C₂₀-alkenyl alcohol.

15: The formulation according to claim 8, wherein said formulation comprises:
(A) 0.1 to 25% by weight of complexing agent (A)
(B) 0.1 to 10% by weight of surfactant (B),
(C) 0.1 to 15% by weight of anionic surfactant (C),
(D) 0.1 to 10% by weight of zwitterionic surfactant, and, optionally,
(E) 0.005 to 5% by weight of graft copolymer (E), and, optionally,
(F) 0.1 to 15% by weight of one n-C₈-C₂₀-alkyl alcohol or at least one n-C₈-C₂₀-alkenyl alcohol,
percentages being based on the total respective formulation.
